(19) United States
(12) Patent Application Publication
(10) Pub. No.: US 2005/0166838 A1
(43) Pub. Date: Aug. 4, 2005

(54) Panels for enclosures and method for assembling enclosures

(76) Inventor: Noel G. Smith, Eau Claire, WI (US)

Correspondence Address: ANTHONY J. BOURGET, P.O. BOX 81, EAU CLAIRE, WI, 54702-0081, US

(21) Appl. No.: 10/735,058

(22) Filed: Dec. 11, 2003

(51) Int. Cl. B05B 1/28; B05C 5/00

(52) U.S. Cl. 118/326

(57) ABSTRACT

A panel for connection with other panels, comprising a rectilinear base member having outer edges, a first rectilinear side member extending from one edge of the base member, the first side member having a first lip extending from an outward edge of the first side member and away from the base member, the first side member further having a second lip extending from an outward edge of the first lip and toward the base member and at an angle between about zero and 90 degrees with respect to the first lip, and a second rectilinear side member extending in substantially the same direction as the first side member, from an opposite edge of the base member, the second side member having a third lip extending toward the base member. Related structural members, enclosures, posts, spray booths and methods for assembling the same which include similar features are provided.

### BACKGROUND OF THE INVENTION

1. Field of the Invention

This invention relates to panels for enclosures and methods for assembling enclosures, and more particularly to a metal spray booth assembly and method for assembling the same.

2. Background Information

Enclosures, or wall systems are useful for a variety of purposes, including housing of items, animals, displays, or other items requiring to be bounded by a structure. Metal enclosures are particularly useful for a spray booth configuration in which a user may, for instance, spray paint or powder coat various articles within the space bounded by the spray booth enclosure which is generally fitted with ventilation units and other items to accommodate removal of hazardous fumes and particulate.

Spray booths are typically assembled from a variety of component parts. The parts are manufactured in one location and then assembled at another location where the booth is intended to be used. Booths usually include several formed and punched panels which are packaged together with assembly hardware to be field erected at the customer's site. The panels are typically connected together in a box-like fashion as is known in the art. Assembly of the booth generally requires use of hardware or fasteners such as rivets, bolts, screws, and the like to hold the panels together; and sometimes booth components will be welded. The panels are formed and punched so as to bolt together to achieve structural integrity. The booth must be structurally sound so as to be free-standing and possibly able to support accessory equipment. The metal enclosures must also withstand demands of the manufacturing environment.

Assembling the spray booth often requires experience and precision, especially in the alignment of booth components and in the use of fastening tools. Assembly must also be made with an understanding of the structural requirements for the use of the booth. Booths can come in a variety of sizes ranging from small table-top spraying units to very large commercial structures useful for purposes of painting automobiles or other large products. In some cases the booths remain stationary for a long period of time. In others, it is desired to move the booths to accommodate flexibility in the manufacturing process.

Typically a spray booth includes a box-like structure having a front opening for insertion of the article to be treated. A typical booth might also include screens or curtains to prevent dissipation of spray materials including odors. A typical ten foot wide×eight foot high×eight foot deep enclosure having a filter wall and exhaust plenum would require 405 nuts and bolts for the enclosure, 110 nuts and bolts for the filter rack, and 24 nuts and bolts for two lights, amounting to a total of 539 nuts and bolts. Also, to insure a dust/vapor seal to be present at the seams, the panels also require a bead of caulking to be applied to abutting surfaces before assembling and bolting. Lights, as required, are bolted in place requiring one person to be positioned inside the enclosure and a person positioned outside the enclosure. Typical booth erection time for two assemblers working together, not including unpacking, floor fastening, and electrical and venting installation, can run approximately five hours per assembler.

A significant drawback in the manufacture or assembly of spray booths is in the time and effort it takes to create and then assemble a workable unit. Moreover, uniformity of assembled units is often desired so as to efficiently produce a quality product. Precision drilling or bolt fastening is often required which takes time and talent and generally the result requires higher labor cost and longer delivery or turnaround times. Multiple assemblers are often required. Working with a variety of awkward parts to be assembled poses a risk for injury in the use or assembling of spray booth parts. Requiring caulking as a step further increases the difficulty, expense, and possible failure of the assembly. Having a complicated booth structure also increases the risk of improper assembly and the potential for structural failure and short product life-cycle. Moreover, a complicated product tends to result in lower uniformity from one assembled enclosure to another.

Accordingly, it would be desirable to develop a booth structure having component parts which are easy to manufacture, and which is capable of being quickly and easily assembled without the use of complicating fasteners and/or extensive caulking. It would further be ideal to provide a booth with component parts that are pre-fabricated to engage with each other so as to create a stable self-supporting structure. In addition, providing a structure than can be assembled with little or no training would have substantial benefit in the marketplace and result in uniformity of structures with greater certainty of stability. Ease of assembly and disassembly also leads to overall manufacturing efficiency given the flexibility for modification of the size of the booth and/or transportation of the booth. Also, reduction of parts would lessen the likelihood of having missing parts or requirement to find replacement parts.

### SUMMARY OF THE INVENTION

The present invention has been made in view of the foregoing disadvantages of the prior art. Accordingly, one aspect of the present invention is to overcome these disadvantages, and further to provide a booth structure which is capable of being assembled without the use of external fastening devices.

It is another aspect of the present invention to provide a spray booth structure which is capable of fast assembly and disassembly.

It is yet another aspect of the present invention to provide a method of assembling a booth structure for use in a variety of areas including use as a spray booth.

It is still a further aspect of the present invention to provide a booth structure which is capable of accomplishing the above-described aspects with a simple structure.

Further aspect of the invention are provided as referenced throughout the specification.

In accordance with the present invention, a panel for connection with other panels is provided. The panel comprises a rectilinear base member having outer edges, a first rectilinear side member extending from one edge of the base member, the first side member having a first lip extending from an outward edge of the first side member and away from the base member, the first side member further having a second lip extending from an outward edge of the first lip and toward the base member and at an angle between about zero and 90 degrees with respect to the first lip, and a second rectilinear side member extending in substantially the same direction as the first side member, from an opposite edge of the base member, the second side member having a third lip extending toward the base member.

In accordance with a further aspect of the present invention, a structural member such as a wall or ceiling is provided. The structural member comprises a first panel, including a rectilinear base member having outer edges, a first rectilinear side member extending from one edge of the base member, the first side member having a first lip extending from an outward edge of the first side member and away from the base member, the first side member further having a second lip extending from an outward edge of the first lip and toward the base member and at an angle between about zero and 90 degrees with respect to the first lip, and a second rectilinear side member extending in substantially the same direction as the first side member, from an opposite edge of the base member, the second side member having a third lip extending toward the base member, and at least one second panel communicatively connected to the first panel, the at least one second panel including a rectilinear base member having outer edges, a first rectilinear side member extending from one edge of the base member, the first side member having a first lip extending from an outward edge of the first side member and away from the base member, the first side member further having a second lip extending from an outward edge of the first lip and toward the base member and at an angle between about zero and 90 degrees with respect to the first lip, and a second rectilinear side member extending in substantially the same direction as the first side member, from an opposite edge of the base member, the second side member having a third lip extending toward the base member.

Further aspects of the invention include related structural members, enclosures, panels, spray booths and methods for assembling the same as described herein.

### BRIEF DESCRIPTION OF THE DRAWINGS

FIG. 1 is a perspective view of one embodiment of an enclosure in accordance with the present invention shown in an exemplary configuration.

FIG. 2 is an exploded perspective view of the enclosure structure shown in FIG. 1 with various components removed for clarity.

FIG. 3 is a perspective view of one embodiment of a side or wall panel of the present invention.

FIG. 4 is a back view of the side panel of FIG. 3.

FIG. 5 is a side view of the side panel of FIG. 3.

FIG. 6 is a top view of the side panel of FIG. 3.

FIG. 7A is a top view of a structural member of the present invention.

FIG. 7B is a partial top view of an alternative structural member of the present invention.

FIG. 8 is a partial perspective view of the structural member and top panel or ceiling of the present invention.

FIG. 9A is a perspective view of one embodiment of a top or ceiling panel of the present invention. FIG. 9B is a side view of the panel of FIG. 9A.

FIG. 10A is a perspective view of another embodiment of the top or ceiling panel of the present invention. FIG. 10B is a side view of the panel of FIG. 10A.

FIG. 11 is partial perspective view of a top or ceiling panel of the present invention.

FIG. 12 is a partial perspective view of an embodiment of the enclosure in accordance with the present invention in partial assembley.

FIG. 13 is a partial perspective view of the structure of FIG. 12 in partial assembly.

FIG. 14 is a perspective view of one embodiment of a post of the present invention.

FIG. 15 is a top view of the post of FIG. 14.

FIG. 16 is a top view of a portion of the structure of the present invention.

FIG. 17 is partial perspective view of a portion of the enclosure of the present invention.

FIG. 18 is a further partial perspective view of the enclosure of FIG. 17.

FIG. 19 is a further partial perspective view of the enclosure of FIG. 17.

FIG. 20 is a top view of a portion of the structure in accordance with the present invention.

FIG. 21 is a top view of a portion of the structure in accordance with a further embodiment of the present invention.

FIG. 22 is a top view of a further embodiment of the panel of the present invention.

FIG. 23 is a top view of a further structural member of the present invention.

FIG. 24 is a top view of a further embodiment of the post of the present invention.

FIG. 25 is a top view of further embodiments of the present invention.

### DESCRIPTION OF THE EMBODIMENTS

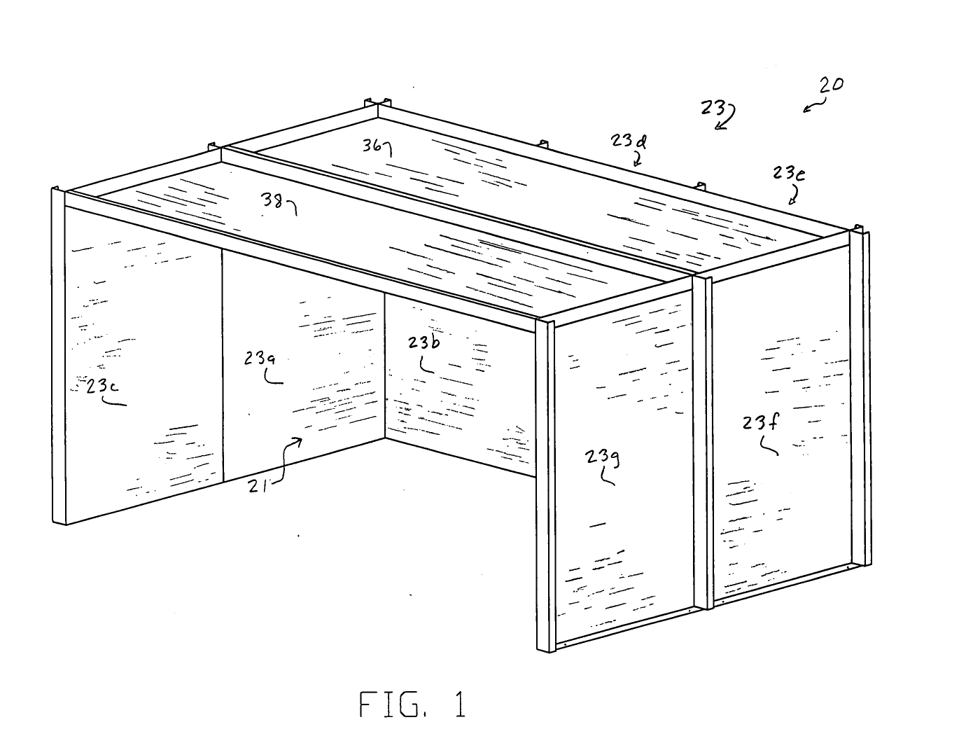

The present invention is directed to a panel for an enclosure, an enclosure, and a method of assembling the enclosure. As shown in FIG. 1, an embodiment of an enclosure is generally indicated at 20. Enclosure 20 generally bounds space 21 and is particularly well-suited for use as a spray booth enclosure 20. Booth 20 may be used to house various items, including use as a shelter for animals, or for a variety of other uses wherein a bounding structure is desired. Booth 20 is particularly useful as a spray booth wherein the articles to be coated with paint or powder, for instance, are placed within space 21. In common fashion, an operator applies the spray to the article (not shown) and generally an exhaust system (not shown) is used to ventilate the spray space area 21. Booth 20 is particularly desirable in that it may be assembled without fasteners such as bolts, rivets, nuts, clamps or other items. It may also be quickly dismantled and transported or stored, and may also be quickly enlarged or modified to accommodate any number of desired uses.

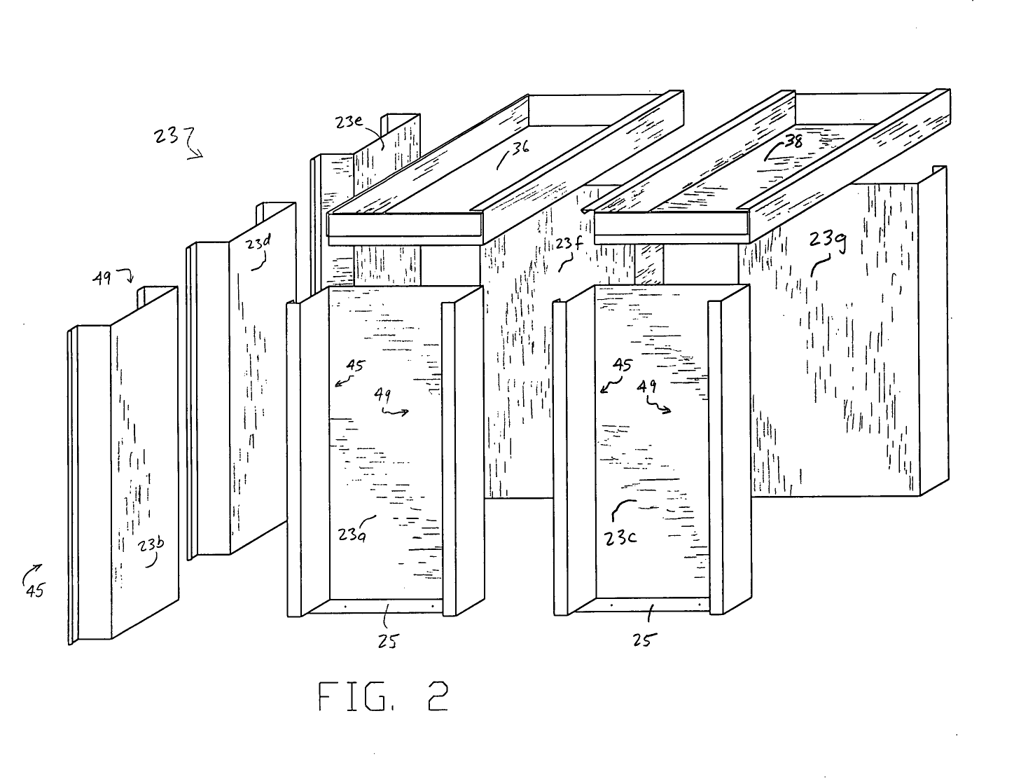

FIGS. 1 and 2 show an exemplary configuration of the booth 20 of the present invention. It is understood that booth 20 can be configured as desired to obtain the desired shape to bound or partially bound any number of different spaces 21 or partially enclosed areas, and that the configuration shown in FIGS. 1 and 2 is illustrative only.

Booth 20 includes a plurality of panels 23 arranged in such a way so as to create a booth wall and booth top to bound space 21. Connecting two panels 23 together creates a wall or the vertical sides and/or back and/or top of the unit. Left side corner panel 23a, left back corner panel 23b, left side panel 23c, middle back panel 23d, right back corner panel 23e, right side corner panel 23f and right side panel 23g create one embodiment of a booth wall. It can be appreciated that panels 23, or some of them, can be modular and can include a plurality of various different panels of various different sizes and shapes which can be arranged together to create the desired booth. Panels 23 also include top edge-type panel 36 and top field-type panel 38. It can be appreciated that a plurality of various side panels, back panels and top panels (generally designated as panels 23) of varying shapes and sizes can be used to create the desired booth. Preferably panels 23 are formed of metal such as steel or aluminum, and it may be appreciated that plastics and combinations of materials may be utilized.

Panels 23 advantageously interlock and are free-standing. Panels 23 have opposite side ends which interlock with side ends of adjacent panels so that the opposing side ends of adjacent panels are interlocked together. For instance, side end 45 of panel 23a engages with side end 45 of panel 23b (as described below); and side end 49 of panel 23a engages with side end 45 of panel 23c. It can be appreciated that multiple panels 23c can be engaged with successive panels 23c to create an extended booth wall structure. It further can be appreciated that multiple panels 23d can be interlocked together to create any desired width of a booth structure. Moreover, the length or height of the panels 23 can be varied to accommodate a desired configuration. While not required, panels 23 are preferably modular for connecting with other like-structure panels.

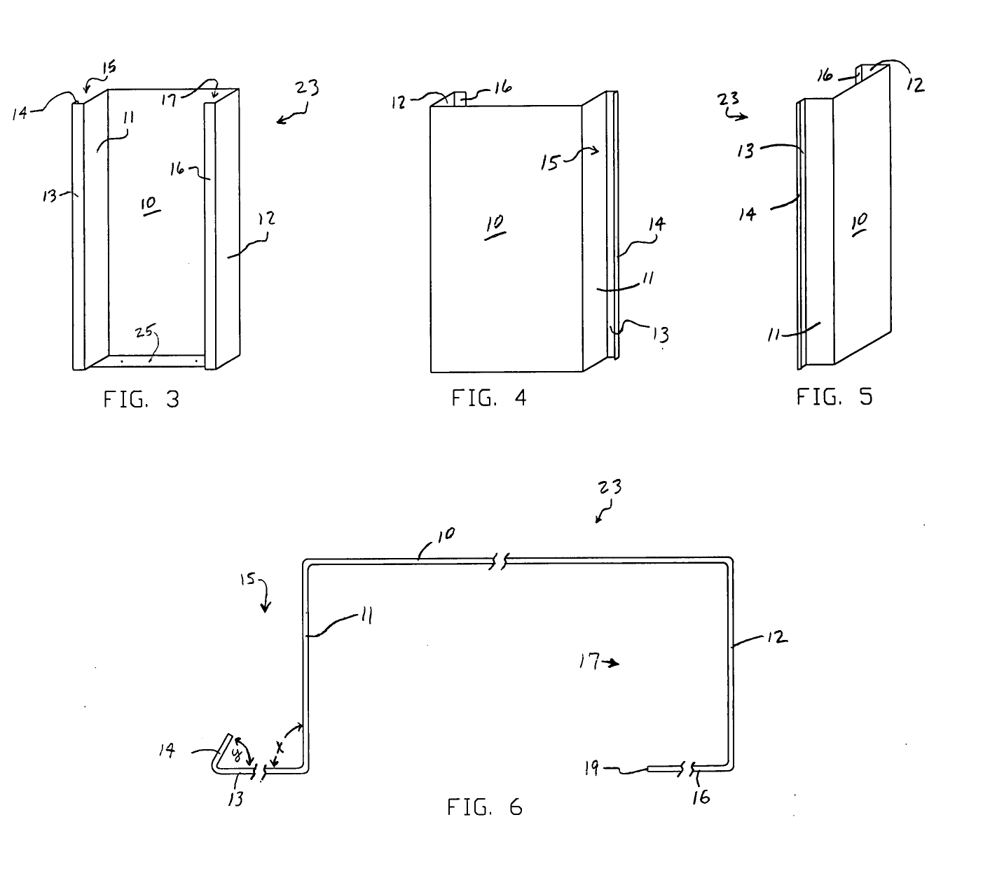

Referring now to FIGS. 3-6, each panel 23a-g has a relatively thin, flat, rectilinearly configured base member 10 of a predetermined area, a first rectilinear side member 11 preferably extending substantially perpendicularly from one edge thereof, and a second rectilinear side member 12 preferably extending substantially perpendicularly from an opposite edge thereof, and in the same direction with respect to the base member 10 as the first side member 11. A first lip 13 preferably extends substantially perpendicularly from the first side member 11 outwardly away from the field of the base member 10 and at an angle “x” (preferably about 90 degrees), and a second lip 14 extends from an outward edge of the first lip 13 at an angle “y” (between about zero and 90 degrees; preferably about 45 degrees) toward the base member 10, thereby defining a first connection channel 15. A third lip 16 preferably extends substantially perpendicularly from the second side member 12 inwardly towards the field of the base member 10 to define a second connection channel 17. The base member 10, first side member 11, second side member 12, and lips 13, 14 and 16 are preferably substantially flat and have predetermined areas and thicknesses. An optional footer 25 extends from an edge of base member 10 to provide additional self-standing support for use as a side panel.

Panels 23, when linked with additional panels 23 form a variety of types of self-standing walls or panels, including vertically disposed walls or horizontally disposed ceilings. Panels 23 are uniquely connectible with other panels without the need for fasteners. A booth can be formed with the fastenerlessly connectible panels to include at least two vertically disposed walls and a horizontally disposed ceiling surrounding at least a partially enclosed area. In this fastenerless or fastener-free connection, there is a lack of fasteners such as bolts, screws, rivets, clamps or the like; and yet the panels and resulting booth are self-supporting. Panels 23 need not be drilled, pinned, tied, nailed, bent, deformed, clamped or otherwise fastened. With a fastenerless connection, less work is required for assembly, and since there is a lack of holes or cracks, the usual caulking of a spray booth assembly is generally avoided. The fastener-free connected panels are ideal for use as a spray booth.

In one aspect of the invention a structural member such as a wall or ceiling is assembled having a first modular panel 23 communicatively connected with at least a second modular panel 23. Preferably, panels 23 are modular.

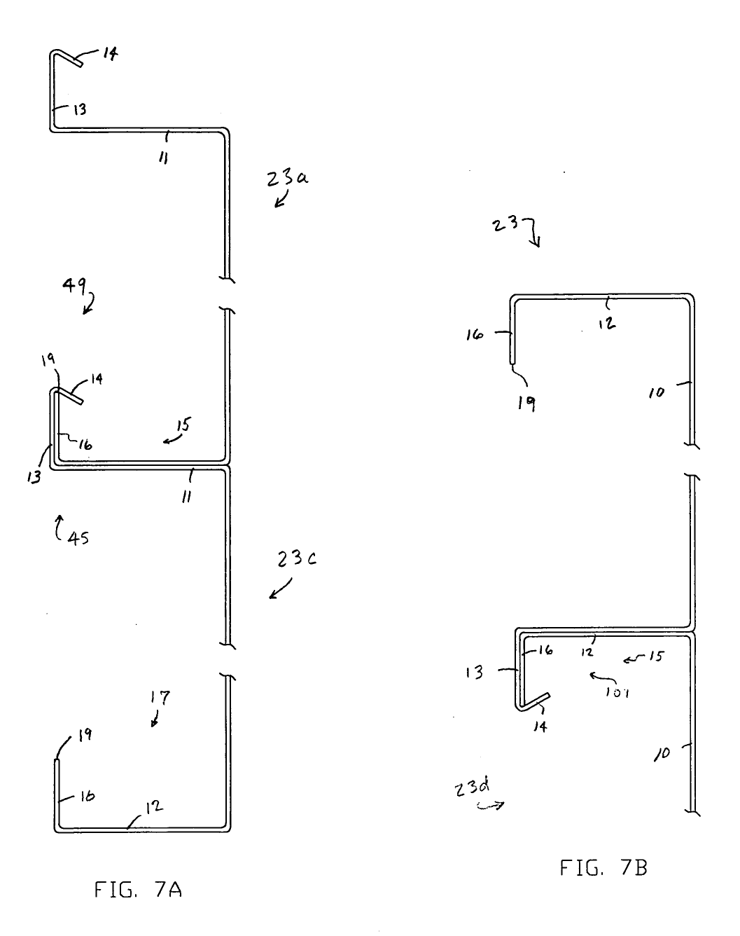

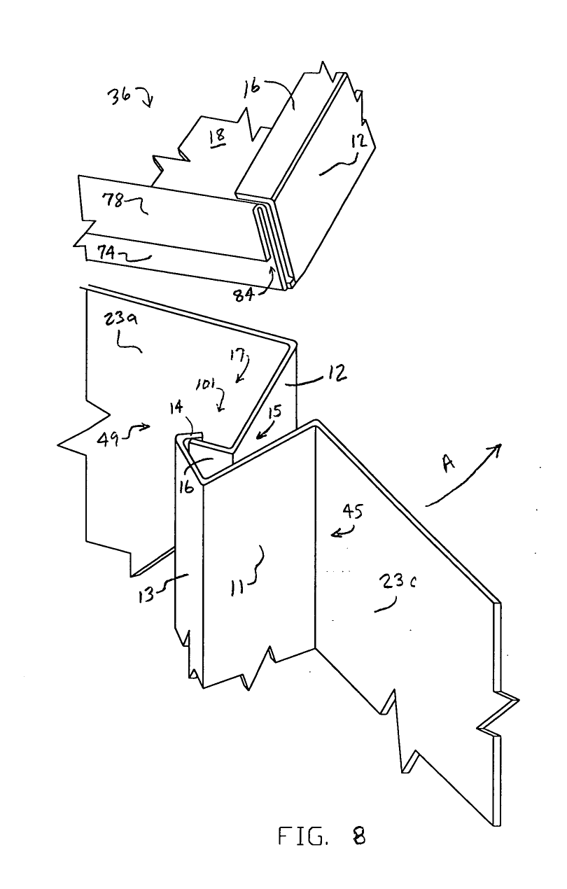

Referring to FIGS. 7A and 7B, adjacent panels 23a, 23c connect where lip 16 of one panel 23a is positioned within channel 15 of an adjacent panel 23b. Preferably a tip portion 19 of lip 16 abuts with second lip 14 of panel 23c for a secure connection. While the connection may be accomplished by lifting one panel 23 over an adjacent panel 23 and sliding the panel and lip 16 downward within channel 15, the preferred connection is to rotationally engage adjacent panels 23. For instance, while a first panel 23a remains relatively stationary, an adjacent panel 23c is positioned such that lip 16 of panel 23a inserts into channel 15 of panel 23c. Second lip 14 of panel 23c is thereby extending within second channel 17 of the first panel 23a. An assembler rotates second panel 23c (or first panel 23a, or both) such that lip 16 of panel 23a engages with lip 13 of panel 23c. Preferably, tip portion 19 of first panel 23a abuts second lip 14 of second panel 23c for secure engagement. Second lip 14 configured at an acute angle with respect to lip 13 inhibits lip 16 from movement within channel 15.

The panels may be connected to form a vertically disposed wall or a horizontally disposed ceiling as desired. Referring to FIG. 8 side panel 23a may be selectively arranged in series with an opposing side panel 23c. Side end 49 engages with side end 45 to connect the adjacent side panels. Side panel 23a includes second side member 12 which extends substantially perpendicular to side panel 23a. Third lip 16 extends substantially perpendicular from side member 112 and together form channel 117 which preferably runs the majority of the length or height of panel 22a. Side panel 23c includes channel 15 defined by lip 13 and first side member 11. Second lip 14 is attached to first lip 13 at an acute angle with respect to first lip 13. Applicant has found that providing second lip 14 at an angle of 90 degrees or greater with respect to first lip 13 will provide unsatisfactory results in that side panels 23 will tend to become disengaged. Preferably second lip 14 is positioned at a 45 degree angle with respect to lip 13. Channel 15 runs the majority of the length or height of panel 23 to thereby sufficiently interlock with adjacent panels. In assembly, lip 16 is inserted into channel 15 at channel opening 101 such that second lip 14 projects into channel 17. Channel opening 101 is defined by first side member 11 and second lip 14. Panel 23c is rotated in the direction of Arrow A to accommodate engagement of the adjacent side panels 23a, 23c in co-linear orientation. It may be appreciated that multiple panels 23c may be provided to form a structural member; and such panels are preferably modular as described above. A top or ceiling panel 36 may also be included with the panels and wall of the invention as shown in FIG. 8 and also as describe later in greater detail.

FIG. 7B illustrates a flipped arrangement of the wall shown in FIG. 7A. It may be appreciated that the arrangement of FIG. 7B may be used as an alternative for the wall of FIG. 7A. Further, the arrangement of FIG. 7B can be utilized, for instance, at a location opposite the arrangement of FIG. 7A when constructing an enclosure such as that of booth 20. In one aspect the arrangement of FIG. 7B shows lip 16 of panel 23d abutting second lip 14 of panel 23 to interlock panels 23d, 23.

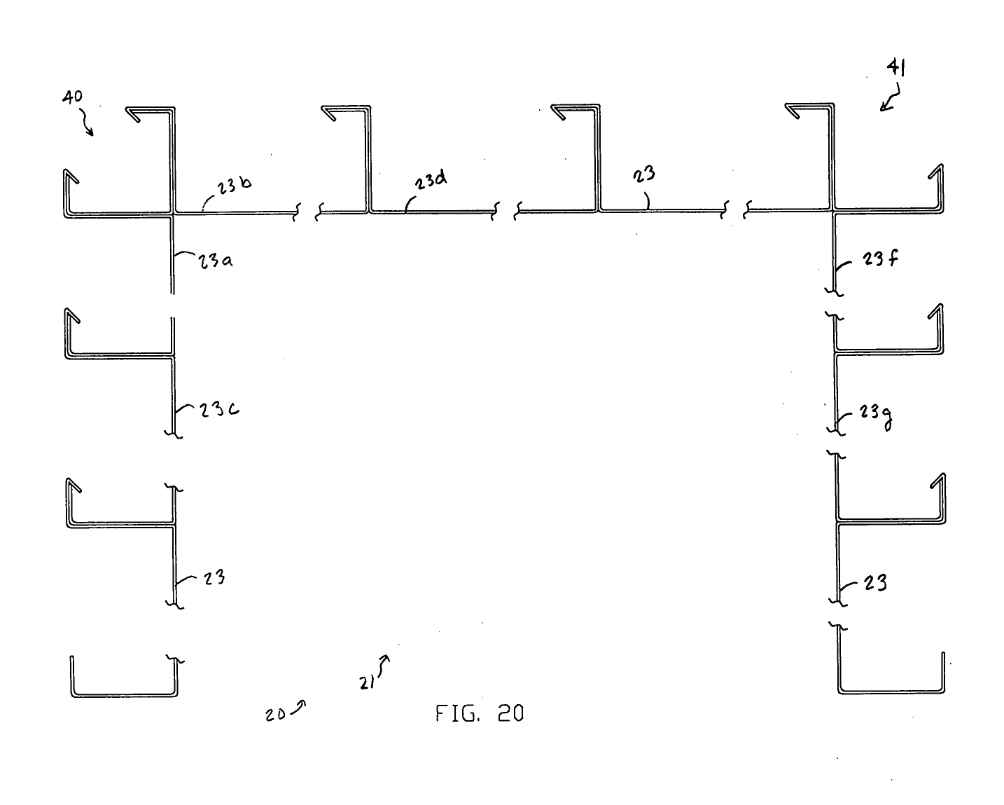

At least two panels 23, for instance panel 23a and panel 23c, may be connected to form a generally linearly configured wall as shown for instance in FIGS. 1, and 20. It may be appreciated that multiple panels 23 may be connected to adjacent panels 23 to create a desired structural member. At least two panels 23 may also be connected to form an angled wall having a least one corner.

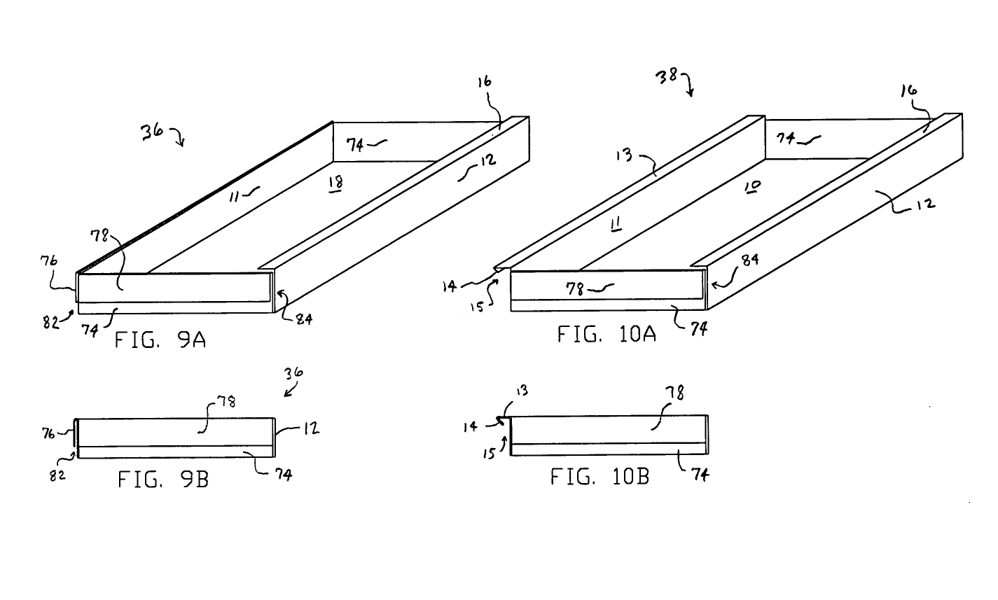

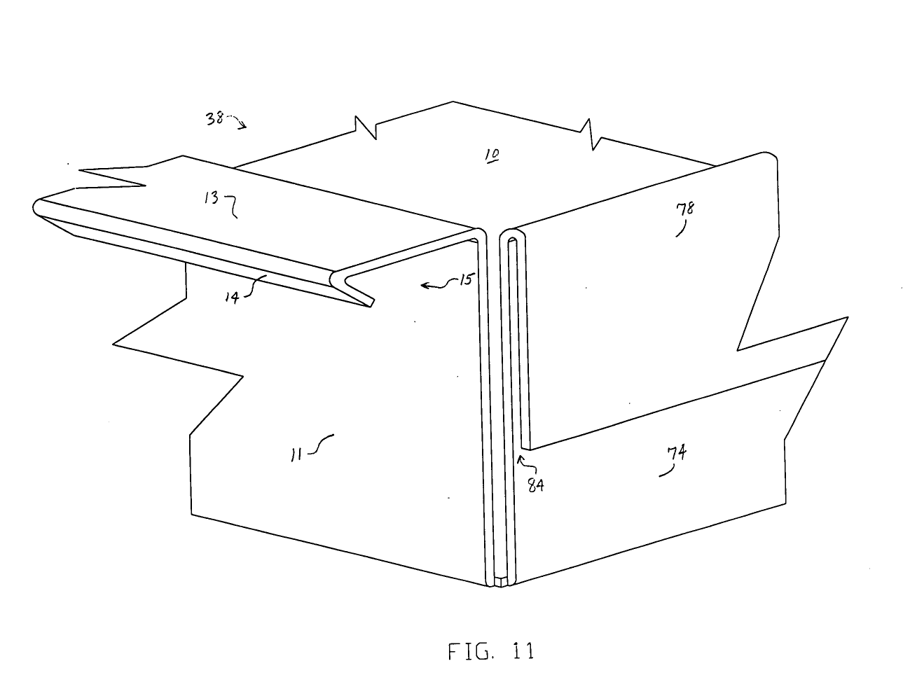

Referring now to FIGS. 9A, 9B and 10A, 10B, an “edge-type” panel 36 and a “field-type” panel 38 are shown, respectively. Panels 36 and 38 are horizontally disposed top or ceiling panels. Panel 38 is modular for connection with other panels. Panel 36 is “edge-type” panel in that it is preferably placed at an edge position of a structure as shown in FIG. 1. Panel 38 is “field-type” in that it is preferably placed within the field or at internal or intermediate locations with respect to an edge position. It may be appreciated that panel 38 includes those features of base member 10 and panel 23 described above, and variations thereof.

Panel 38 as shown in FIGS. 10A, 10B and 11 further includes mutually opposed shoulder walls 74 extending generally perpendicularly from opposite edges of the relatively thin, flat, rectilinearly configured base member 10 of a predetermined area. Each shoulder wall 74 preferably includes a slot wall 78 extending from the shoulder wall 74 toward base member 10. Shoulder wall 74 and slot wall 78 define a slot 84. Preferably slots 84 are provided at opposite edges of panel 38 for connection with side or wall panels 23. Panel 38 is connectible with other panels 38 and/or 23 without fasteners to form a horizontally disposed top wall or ceiling. Panel 38 connects to an adjacent horizontally oriented panel 23 by positioning lip 16 within channel 15. Preferably, a tip portion 19 of lip 14 abuts with a corner of an adjacent panel 23 where lip 13 meets with second lip 14. Lip 14 extends from an outward edge of the first lip 13 at an angle between about zero and 90 degrees, and preferably about 45 degrees. Preferably, lip 16 engages within a majority of the length of channel 15. Channel 15 may be rotationally engaged with lip 16 to provide secure connection. Panel 38 may connect with similar panels 38, including an edge type panel 36. It may be appreciated that a panel 23, such as panel 23a, may be horizontally oriented for use as a top panel 38; however, top panel 38 includes slots 84 for overlay engagement with panels 23, and typically does not include a footer 25.

Panel 36 as shown in FIG. 9A includes mutually opposed shoulder walls 74 extending generally perpendicularly from opposite edges of the relatively thin, flat, rectilinearly configured edge base member 18 of a predetermined area. Each shoulder wall 74 preferably includes a slot wall 78 extending from the shoulder wall 74 toward base member 18. Shoulder wall 74 and slot wall 78 define a slot 84. Preferably slots 84 are provided at opposite edges of panel 36 for connection with side or wall panels 23. A first rectilinear side member 11 preferably extends generally perpendicularly from one edge of base member 18, and a second rectilinear side member 12 preferably extends generally perpendicularly from an opposite edge thereof, and in the same direction with respect to the base member 18 as the first side member 11. A lip 16 preferably extends substantially perpendicularly from the second side member 12 inwardly towards the field of the base member 18 to define a connection channel 17. As shown in FIG. 9B, a slot wall 76 extends downwardly from side member 11 toward base member 18 and defines a slot 82, preferably running the length of base member 18. Slot 82 connects with a vertically disposed side or wall panel, such as panel 23b at a back portion of an enclosure. Lip 16 preferably connects with an adjacent horizontally disposed top panel 38 at a channel 15. No fasteners are required for the connection. Slot wall 76 of panel 36 may include edge gaps (not shown) for desired clearance fitting around first side members 11 and/or second side members 12 of vertically oriented panels 23 (such as panels 23b, 23d, 23e) at a back portion of the enclosure.

It may be appreciated that multiple panels 23 may be connected without fasteners to form a booth 20 with at least two vertically disposed walls and a horizontally disposed ceiling surrounding at least a partially enclosed area. Such booth is ideal for use as a spray booth.

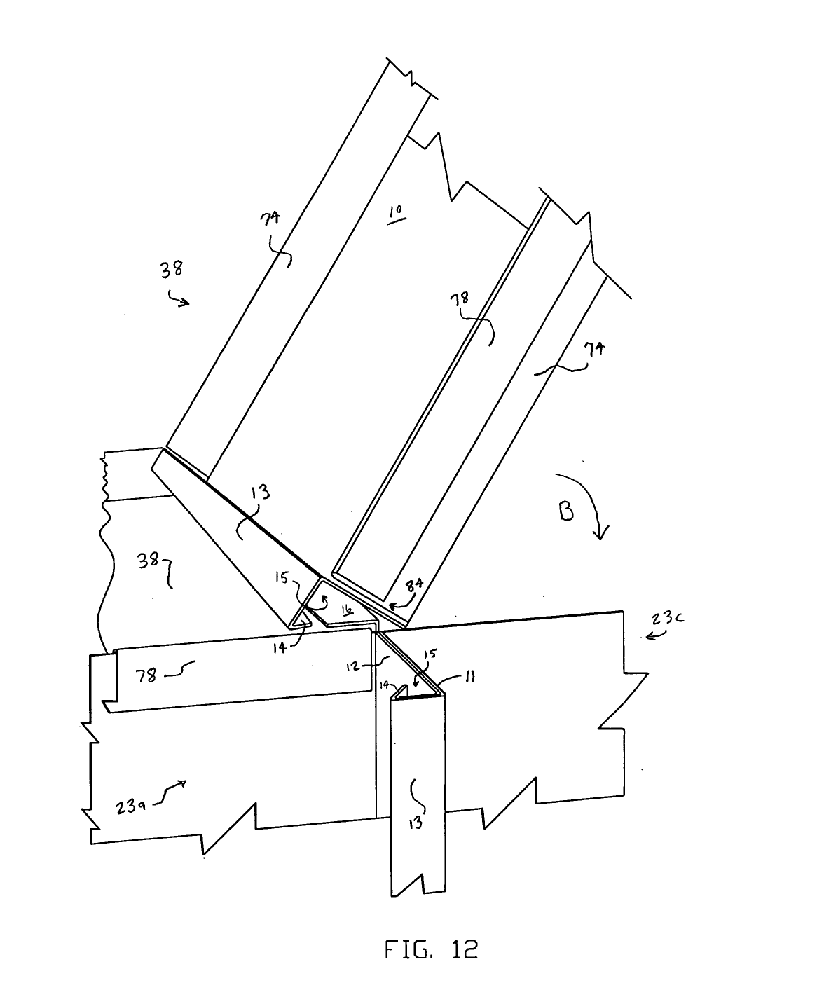

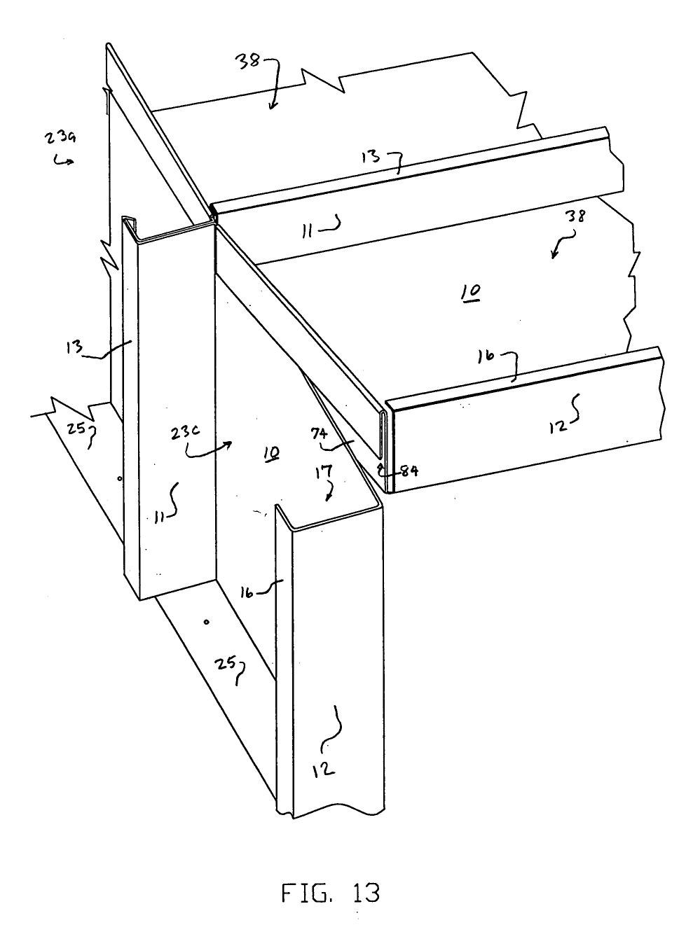

As shown in FIGS. 12 and 13, top panel 38 includes shoulder wall 74 and slot wall 78 defining slot 84. Slot 84 drops over side wall 23 for secure engagement. Second lip 14 is attached to first lip 13 at an acute angle with respect to first lip 13. Lip 13, lip 14 and side member 11 define channel 15. Second lip 14 inhibits panel 38 from movement. Channel 15 runs the majority of the length or width of panel 38 to provide for solid secure engagement with adjacent top panel 36 or other panels 38.

In assembly, top panel 38 drops over to engage side panel 23 and also engages with top panel 36 (or 38) at channel 15 by receiving lip 16. Panel 38 preferably moves in the direction of arrow B as shown in FIG. 12 for locking engagement. Preferably, lip 16 abuts lip 14 for secure connection. FIG. 13 shows panel 38 in nearly complete engagement with panel 38, 23a and 23c. It can be appreciated that panel 38 also engages with panel 36, and other panels 23. In position, top panel 38 prevents side panel 23c from rotating outward from its engaged position with side panel 23a. Further, first lip 13 provides substantial cross support for a top or ceiling of booth 20 for rigid free-standing and sturdy alignment. Lip 13 provides structural support so that top panels 38 may be equipped with components for use as a spray booth, specifically, lights, exhausts vents or fans, or other components (not shown) which may necessarily be placed in or on panels 23 or otherwise on top of booth 20.

It may be appreciated that the aspects of the invention referenced in FIGS. 7A, 7B, and 8 may accommodate a booth structure having panels 23, yet lacking a post such as post 40. A variety of corner configurations and or posts can be utilized for an enclosure, while still recognizing the independent benefits derived from side panels 23 configured with the acutely angled second lip 14 as described. Moreover, such arrangement in conjunction with a top panel 38 provides for efficient and stable co-linear arrangement of panels 23 for a booth structure 20.

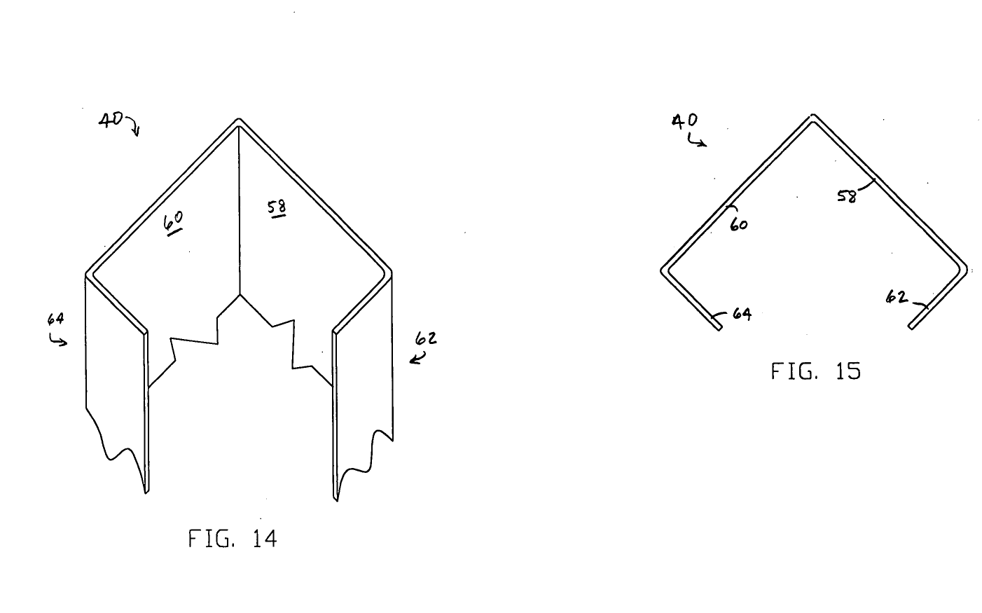

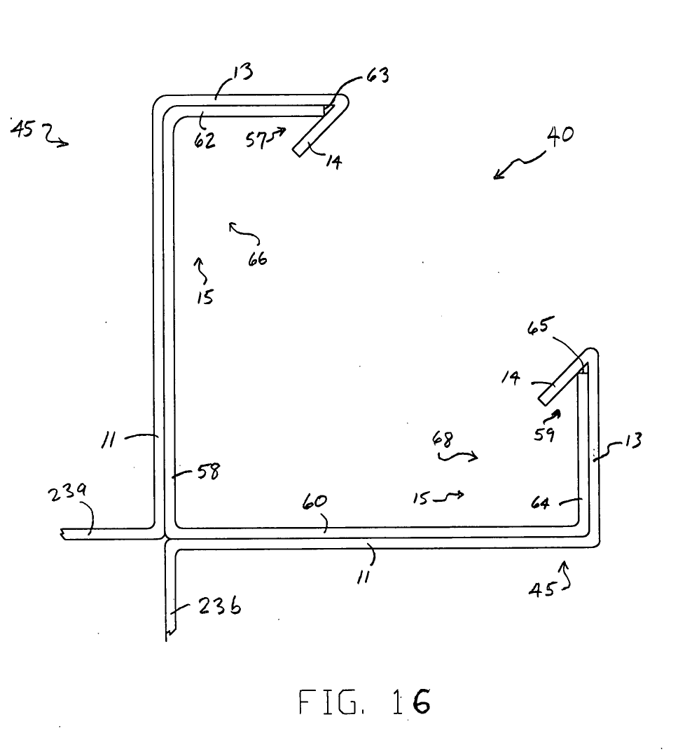

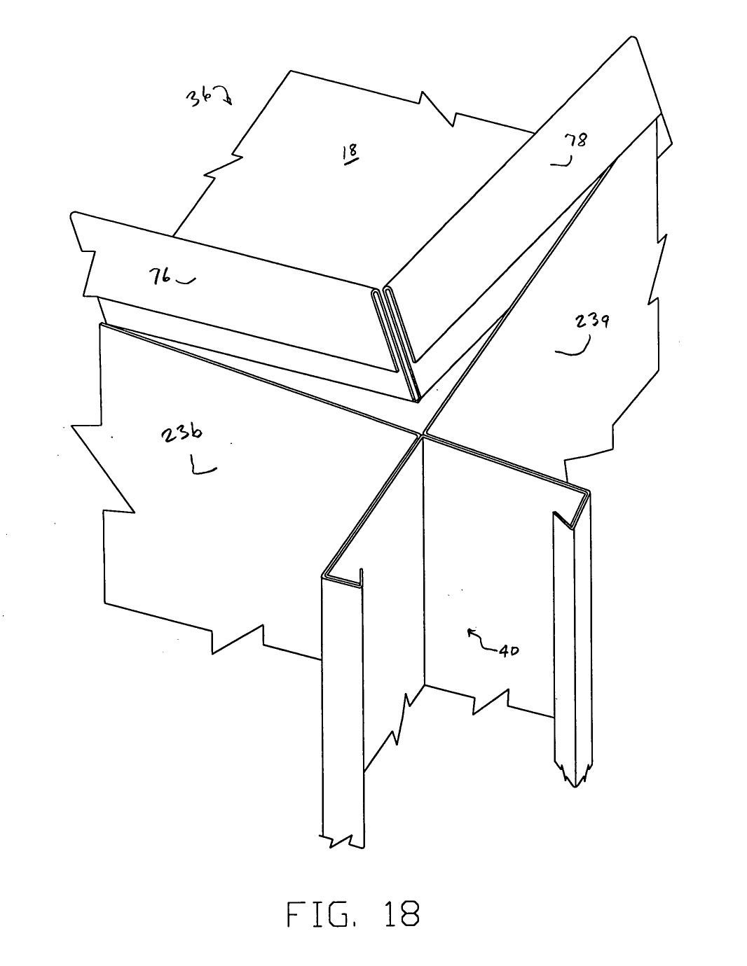

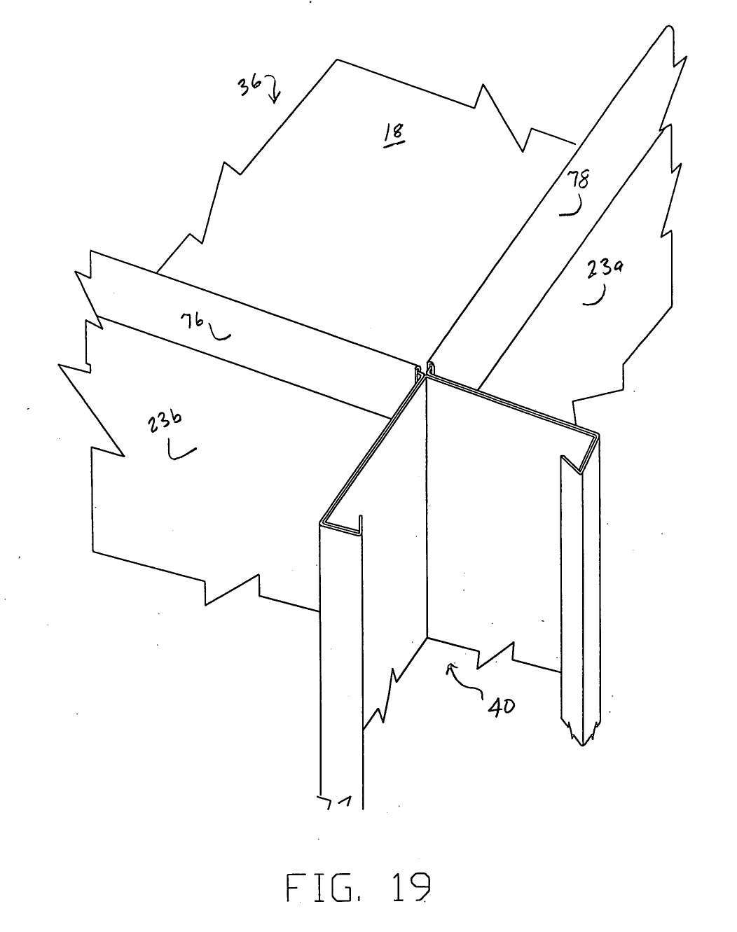

Referring now to FIGS. 14, 15, and 16, a post and a corner configuration aspect of the invention are shown. A generally winged-L-shaped post 40 includes rectilinear post walls 58, 60 extending substantially perpendicularly from each other. Post walls 58, 60 are preferably rectilinear and connect with each other to form a generally L-shaped configuration. Rectilinear post wings 62, 64 extend substantially perpendicularly from post walls 58, 60 and toward each other. Preferably, post walls 58, 60 are perpendicular to each other, and post wings 62, 64 are perpendicular to the respective post walls 58, 60. Corner post 40 couples together two panels 23a, 23b in a substantially perpendicular orientation. Post wing 62 engages with channel 15 of an adjacent panel 23a. Preferably post 40 is rotationally engaged within channel 15 by movement of panel 23a in the direction of arrow C as shown in FIG. 17. A similar engagement is accomplished with respect to post wing 64 and panel 23b to couple together panels 23a and 23b.

Referring to FIG. 17, panel 36 engages with the wall structure of panels 23. Slot 82 drops over the edge of panel 23b at a back portion of the enclosure for secure engagement while slot 84 drops over the edge of panel 23a at a side portion of the enclosure. It may be appreciated that panel 23a is rotated into position as shown by arrow C prior to drop-down of panel 36. Panels 23a and 23b form a structural member and together with post 40 form a self-supporting fastener-less corner structural member and enclosure. Together with panel 36 the self-supporting structural member and enclosure is further stabilized and fastenerlessly locks the panels 23a and 23b into position.

In one aspect of the invention, an enclosure 27 includes at least two panels 23 of a modular variety as described above and at least one corner post 40 communicatively connected to the two modular panels 23 to cooperate to form at least two walls. Additional modular panels 23 may be connected to form a linearly configured wall; and at least one ceiling panel 36, 38, may be connected to the two walls. In a further aspect, a self supporting, fastenerless spray both includes at least one wall having at least two modular wall panels as described herein, and at least one ceiling having at least one panel as described herein. One of the ceiling panels is preferably an edge-type panel 36.

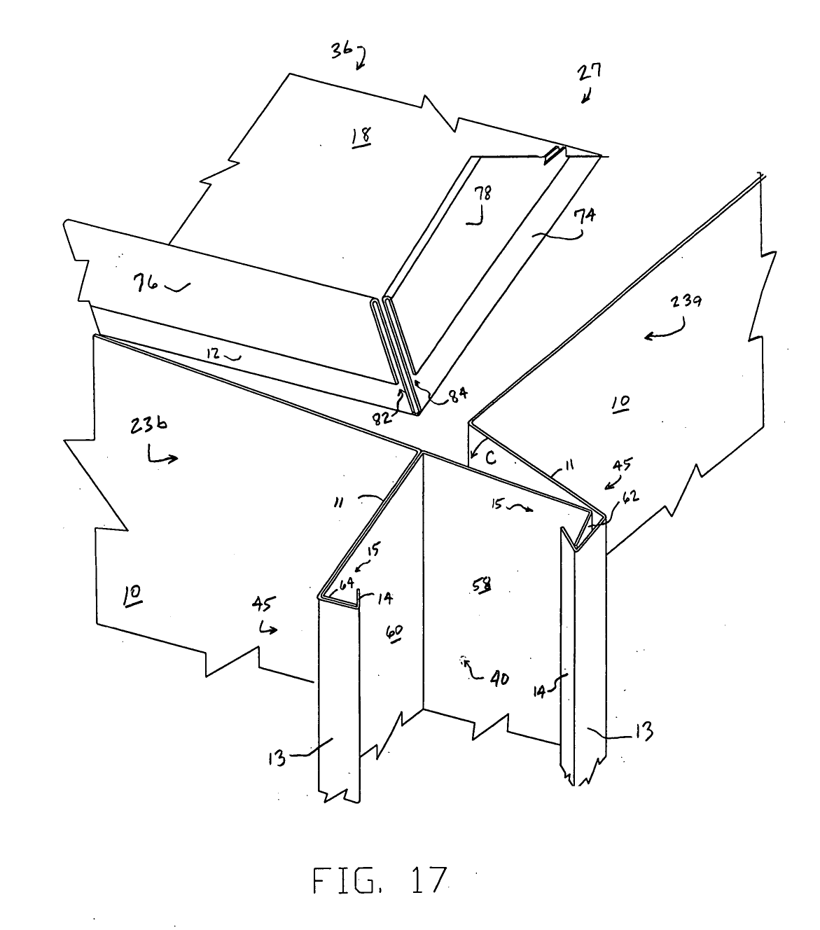

Post 40 is a generally “winged-L-shaped” coupler as shown, which cooperates with channels 15 of opposing panels 23a, 23b to removeably couple the side panels together. [redundant]]Post 40 includes post walls 58, 60 arranged substantially perpendicularly to each other in a generally L-shaped cross section, and post wings 62, 64 positioned at a substantially perpendicular orientation with respect to post walls 58, 60. As shown in FIG. 15, channel hook walls 54, 56 project generally inward toward each other or toward the intersection of post walls 58, 60.

Preferably post 40 runs a majority of the length or height, or the entire length or height, of panels 23 for interlocking the entire length or height of the side ends 45 of adjacent panels 23a, 23b.

Panels 23a, 23b each include channel openings 66, 68 defined by first side member 11, and second lip 14, respectively. Openings 66, 68 provide a clearance between the end of second lip 14 and side member 11. The clearance has a length shorter than the length of post wings 62, 64. Preferably, post wings 62, 64 abut second lip 14 when post walls 58, 60 are positioned against side members 11. In such configuration, panels 22a, 23b are sufficiently interlocked so as to inhibit movement. Post wings 62, 64 also preferably abut first lips 13 in such configuration. Preferably post wings 62, 64 abut second lips 14 at post wing ends 63, 65. First lip 13 and second lip 14 define hook-corners 57, 59 where post 40 is engaged with side panels 23a, 23b at the hook corners 57, 59.

For assembly, post 40 is inserted into channel openings 66, 68. Preferably channels 15 run a majority of the length or height, or the entire length or height, of panels 22 for interlocking the entire length or height of the side ends 45 of adjacent panels. Post wing 62 engages with first lip 13 and abuts second lip 14 of panel 23, while post wall 58 is positioned against side member 11. Preferably, post 40 rotationally engages within channels 15. In assembly, an operator may select to first receive post 40 within channel 15 of panel 23a, and then proceed to secure post 40 to adjacent panel 23b. Alternatively, an operator may select to first receive post 40 within channel 15 of panel 23b as described below, and then receive post 40 within channel 15 of panel 23a. While not preferred, as an alternative to rotationally engaging together post 40 and channels 15, an operator may position panel 23 so as to slide panel 23 at channel 15 downward to engage post wing 62; however, this requires lifting, stabilizing and drop-placement of the panel.

In order to insert post wing 62 into channel opening 66, post 40 is preferably rotated to allow post wing 62 sufficient clearance to enter the opening 66. Otherwise, post wing 62 would abut second lip 14 and prevent insertion of post wing 62 into hook corner 57. It may be appreciated that either post 40 or panel 23, or both, may be rotated to achieve the desired engagement; and reference herein to post 40 rotating for engagement is equivalent to having a panel rotated. It may also be appreciated that an assembler may begin assembly by receiving post 40 within channel 15 and thereafter secure post 40 to the adjacent side panel 23a (as is reflected in FIG. 17), or begin by receiving post 40 within channel 15 of panel 23a and thereafter secure post 40 to the adjacent side panel 23b. Thus, assembly may be achieved in a variety of steps in keeping within the scope of the present invention.

In one instance, post wing end 63 is introduced first within channel opening 66 and positioned to abut second lip 14 at hook corner 57. Post wing 62 thereby inhibits movement of panel 23 in a direction opposite post wing end 63. Further, second lip 14 inhibits post wing 62 from movement in the direction opposite panel 23a. A similar engagement may be obtained with respect to panel 23b. Post 40 is securable to an adjacent side panel 23b while also being rotationally engageable with channel 15 of panel 23a to releasably engage panel 23a to connect the panels together. Such rotational engagement is preferred since assembly may be accomplished by positioning the panels 23 and post 40 at the same level. It may be appreciated that the panels 23 could slide vertically into position with respect to the post 40 (i.e., by lifting a panel 23 and sliding it into the position where the post 40 inserts into channels 15. However, to do so would require lifting of the panels 23 which may require additional overhead clearance and adds an extra expense of labor and assembly difficulty to accommodate appropriate insertion. Thus, rotation of a panel 23 into position provides for an easy and quick assembly. Further, such positioning, whether rotational or by sliding, is obtained without use of screws, rivets, bolts or other fastening devices. Drilling of holes within panels 23 may be eliminated.

As shown in FIG. 19, panels 23a, 23b have been connected with post 40 to provide a side wall structure. Thereafter, top panel 36 is applied to the structure 20 to accommodate further use, stability, and locking. Preferably top panel 36 drops over to interlock the side panels 23 together.

Referring again to FIG. 17, top panel 36 includes slots 82, 84. Slots 82, 84 are defined by shoulder walls 70, 74 and slot walls 76, 78. Slots 82, 84 are designed to drop over side panels 23. Top panel 36 is positioned over respective side panels 23, such that booth 20 includes a corner area which is firmly engaged in position and provides a sturdy, free-standing structure. With top panel 36 in position, side panels 23 are inhibited from rotating away from post 40 and are therefore interlocked into position.

Referring to FIG. 20, a further aspect of the booth 20 is shown. It may be appreciated that a plurality of panels 23 may be utilized to form any desired size of booth 20.

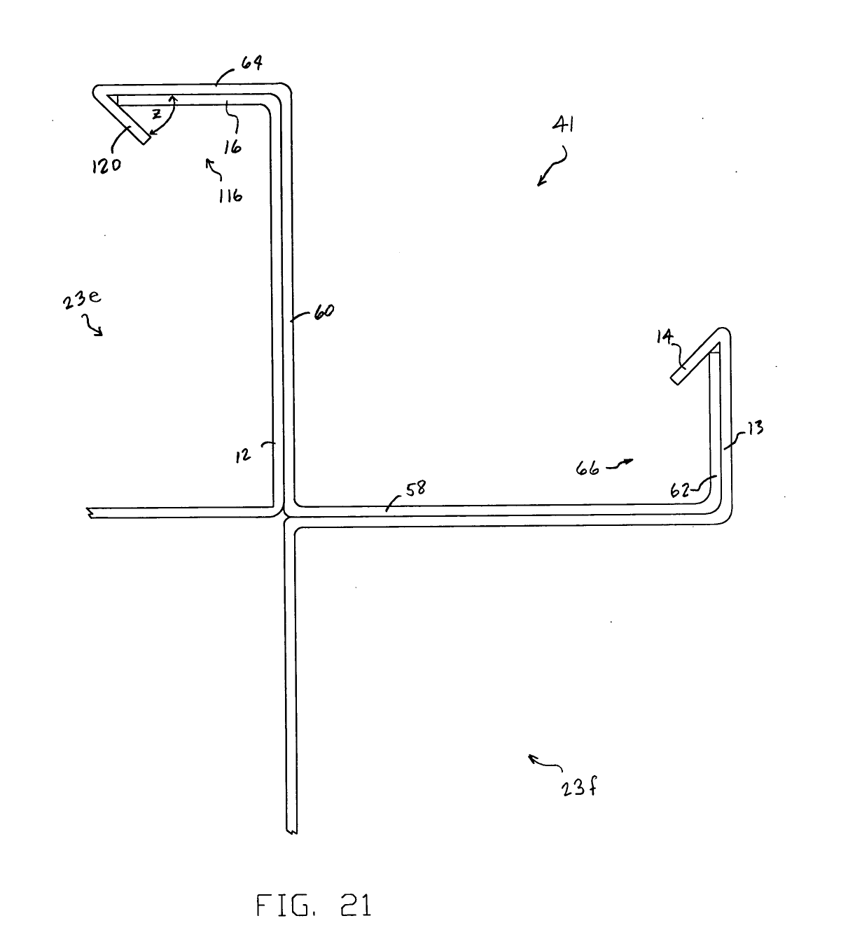

A further embodiment of the post aspect of the invention includes post 41 for coupling two panels such as panels 23e and 23f. As shown in FIG. 21, post 41 includes post walls 58, 60 preferably oriented perpendicularly to each other. FIG. 21 shows walls 58, 60 directly connected. Each post wall 58, 60 includes a post wing 62, 64 extending substantially perpendicularly from the respective post walls 58, 60. Post wing 64 in this embodiment extends outward or away from the opposite post wall 58. Post wing 64 includes a post hook wall 120 at an angle “z” with respect to the post wing 64. Angle “z” is between about zero and 90 degrees, and preferably about 45 degrees. Post 41 is particularly useful for forming a corner opposite the corner arrangement described previously. Post wing 64, post hook wall 120, and post wall 60 define post channel 116. Preferably post channel 116 runs a majority of the length or height, or the entire length or height, of panel 23 for interlocking the entire length or height of the side ends of adjacent panels. Post channel 116 receives third lip 16 which extends from second side member 12 of panel 23. Third lip 16 abuts post hook wall 120 and inhibits separation of panel 23 from adjacent panel 23f. Post channel 116 is formed opposite post wing 62. Side panel 23 is rotationally engageable within post channel 116 to releasably engage side panel 23 to the side end 45 of side panel 23f. As shown in FIG. 21, post 41 is a generally S-shaped coupler which cooperates with opposing side panels 23, 23f to removeably hold the panels together.

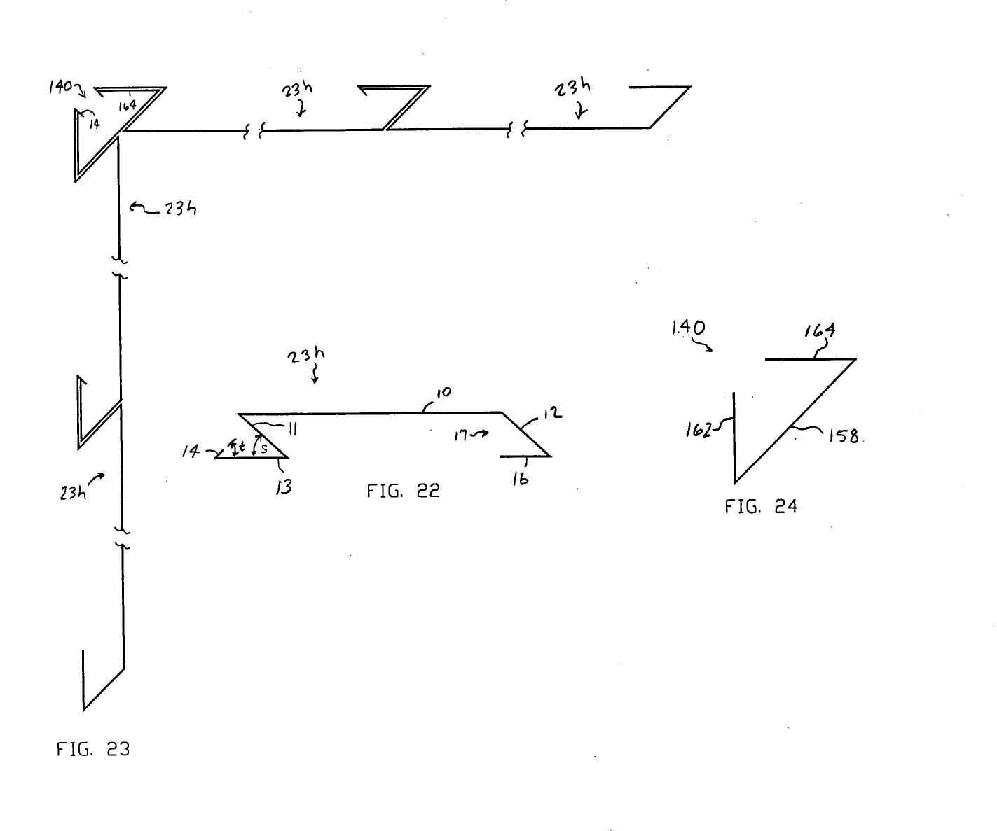

Referring to FIGS. 22-24, further embodiments of the panel 23 and resulting structural members are shown. Panel 23h has a relatively thin, flat, rectilinearly configured base member 10 of a predetermined area, a first rectilinear side member 11 extending from one edge thereof, and a second rectilinear side member 12 extending from an opposite edge thereof, and in the same direction with respect to the base member 10 as the first side member 11. First member 11 extends at an acute angle with respect to base member 10. A first lip 13 extends from the first side member 11 outwardly away from the field of the base member 10 and at an angle “s” (preferably at an acute angle), and a second lip 14 extends from an outward edge of the first lip 13 at an angle “t” (between about zero and 90 degrees; preferably about 45 degrees) toward the base member 10, thereby defining a first connection channel 15. A third lip 16 extends from the second side member 12 inwardly towards the field of the base member 10 to define a second connection channel 17. The base member 10, first side member 11, second side member 12, and lips 13, 14 and 16 are preferably substantially flat and have predetermined areas and thicknesses. Panel 23h may be modular.

FIG. 23 shows multiple panels 23h configured to form a structural member. Panels 23h are preferably rotated into position as described previously with respect to panels 23. Both a corner arrangement and co-linear arrangement may be accomplished with panels 23h.

FIG. 24 shows a further embodiment of post 140 having a rectilinear post wall 158. Post wings 162, 164 extend toward each other from opposite ends of the post wall 158. Each post wing 162, 164, is positioned at an acute angle with respect to the post wall, and are preferably oriented perpendicularly with respect to each other. In assembly, post wing 164 preferably abuts second lip 14 of panel 23h. A similar abutment occurs with respect to post wing 162.

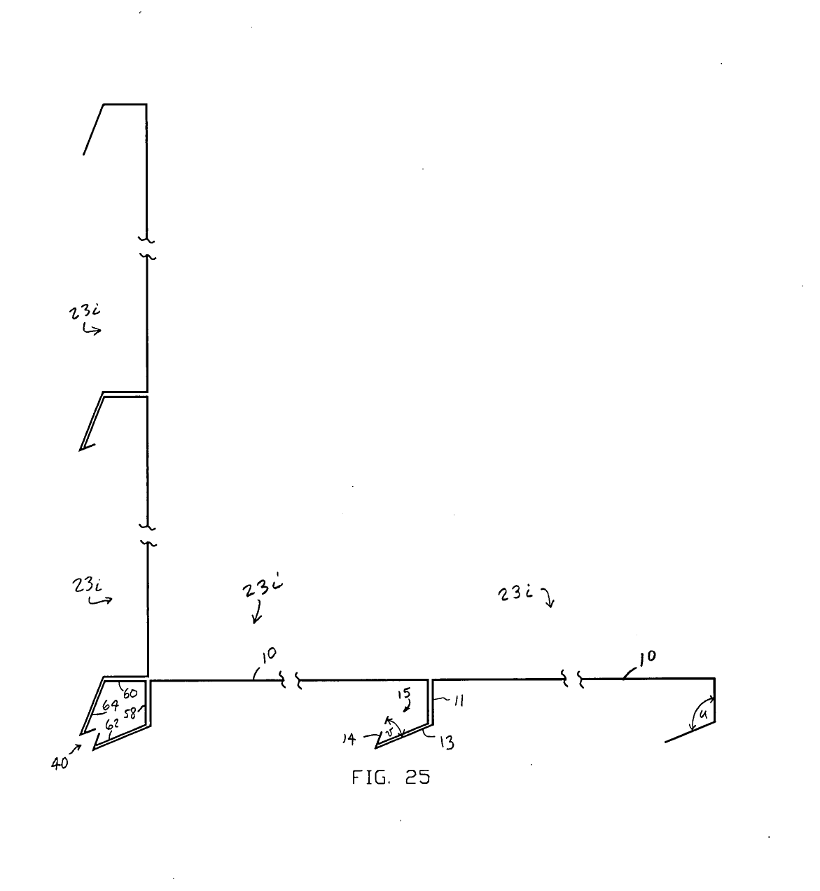

FIG. 25 show a further embodiment of panel 23 and resulting structural member. Panel 23i includes a relatively thin, flat, rectilinearly configured base member 10 of a predetermined area, a first rectilinear side member 11 extending from one edge thereof, and a second rectilinear side member 12 extending from an opposite edge thereof, and in the same direction with respect to the base member 10 as the first side member 11. First member 11 extends generally perpendicularly with respect to base member 10. A first lip 13 extends from the first side member 11 outwardly away from the field of the base member 10 and at an obtuse angle “u”, and a second lip 14 extends from an outward edge of the first lip 13 at an acute angle “v” (preferably about 45 degrees) toward the base member 10, thereby defining a first connection channel 15. A third lip 16 extends from the second side member 12 inwardly towards the field of the base member 10 to define a second connection channel 17. The base member 10, first side member 11, second side member 12, and lips 13, 14 and 16 are preferably substantially flat and have predetermined areas and thicknesses. Panel 23i may be modular.

FIG. 25 also shows multiple panels 23i configured to form a structural member. Panels 23i are preferably rotated into position as described previously with respect to panels 23. Both a corner arrangement and co-linear arrangement may be accomplished with panels 23i.

FIG. 25 also shows a further embodiment of post 40 having post wings 62, 64 extending from generally perpendicularly disposed post walls 58, 60 at obtuse angles. Post wings 62, 64 preferably abut second lips 14 of adjacent panels 23i to lock the panels 23i into position.

In further aspects of the present invention, methods of assembly of an enclosure and spray booths are provided. One method includes the steps of providing the structures disclosed above, and rotationally engaging the post 40 within at least one of the channels 15. An adjacent side panel 23 is secured to post 40 to engage side ends of the adjacent side panels 23 to form a booth wall.

The descriptions above and the accompanying drawings should be interpreted in the illustrative and not the limited sense. While the invention has been disclosed in connection with the preferred embodiment or embodiments thereof, it should be understood that there may be other embodiments which fall within the scope of the invention as defined by the following claims. Where a claim is expressed as a means or step for performing a specified function it is intended that such claim be construed to cover the corresponding structure, material, or acts described in the specification and equivalents thereof, including both structural equivalents and equivalent structures

1. A panel for connection with other panels, comprising:
a. a rectilinear base member having outer edges;
b. a first rectilinear side member extending from one edge of the base member, the first side member having a first lip extending from an outward edge of the first side member and away from the base member, the first side member further having a second lip extending from an outward edge of the first lip and toward the base member and at an angle between about zero and 90 degrees with respect to the first lip; and
c. a second rectilinear side member extending in substantially the same direction as the first side member, from an opposite edge of the base member, the second side member having a third lip extending toward the base member.

2. The panel of claim 1, wherein the panel is modular, and wherein the first side member extends generally perpendicularly from the base member, the second side member extends generally perpendicularly from the base member, and the third lip extends generally perpendicularly from the second side member.

3. The panel of claim 1, wherein the panel is a vertically disposed wall panel.

4. The panel of claim 1, wherein the panel is a horizontally disposed ceiling panel.

5. The panel of claim 1, wherein the panel is connectible with at least one other panel without fasteners.

6. The panel of claim 5, wherein the panel is connectible to form a vertically disposed wall.

7. The panel of claim 5, wherein the panel is connectible to form a horizontally disposed ceiling.

8. The panel of claim 5, wherein the panel is connectible to form a booth with at least two vertically disposed walls and a horizontally disposed ceiling surrounding an at least partially enclosed area.

9. The panel of claim 8, wherein the booth is a spray booth.

10. A structural member such as a wall or ceiling, comprising:
a. a first panel, including:
i. a rectilinear base member having outer edges;
ii. a first rectilinear side member extending from one edge of the base member, the first side member having a first lip extending from an outward edge of the first side member and away from the base member, the first side member further having a second lip extending from an outward edge of the first lip and toward the base member and at an angle between about zero and 90 degrees with respect to the first lip; and
iii. a second rectilinear side member extending in substantially the same direction as the first side member, from an opposite edge of the base member, the second side member having a third lip extending toward the base member; and
b. at least one second panel communicatively connected to the first panel, the at least one second panel including:
i. a rectilinear base member having outer edges;
ii. a first rectilinear side member extending from one edge of the base member, the first side member having a first lip extending from an outward edge of the first side member and away from the base member, the first side member further having a second lip extending from an outward edge of the first lip and toward the base member and at an angle between about zero and 90 degrees with respect to the first lip; and
iii. a second rectilinear side member extending in substantially the same direction as the first side member, from an opposite edge of the base member, the second side member having a third lip extending toward the base member.

11. The structural member of claim 10, wherein the first and the at least one second panels are modular and are connected, the third lip of the second panel abutting the second lip of the first panel.

12. The structural member of claim 11, wherein the first side members of the first panel and of the at least one second panel extend generally perpendicularly from the respective base members, the second side members extend generally perpendicularly from the respective base members, and the third lips extend generally perpendicularly from the respective second side members.

13. The structural member of claim 10, wherein the first and at least one second panel are connected to form a linearly configured wall.

14. The structural member of claim 10, wherein the first and at least one second panels are connected to form an angled wall having at least one corner.

15. The structural member of claim 14, further comprising a corner post coupling two panels, the post comprising at least two post walls oriented generally perpendicularly to each other, each post wall including a post wing extending from the post wall and toward each other.

16. The structural member of claim 14, further comprising a corner post coupling two panels, the post comprising at least two post walls oriented substantially perpendicularly to each other, each post wall including a post wing extending substantially perpendicularly from the post wall, at least one of the post wings including a post hook wall extending from the post at least one post wing and at an angle between about zero and 90 degrees with respect to the at least one post wing.

17. The structural member of claim 14, further comprising a corner post coupling two panels, the post comprising a rectilinear post wall including at least two post wings extending toward each other from opposite ends of the post wall, each post wing positioned at an acute angle with respect to the post wall.

18. An enclosure, comprising:
a. at least two panels, each panel including:
i. a rectilinear base member having outer edges;
ii. a first rectilinear side member extending from one edge of the base member, the first side member having a first lip extending from an outward edge of the first side member and away from the base member, the first side member further having a second lip extending from an outward edge of the first lip and toward the base member and at an angle between about zero and 90 degrees with respect to the first lip; and
iii. a second rectilinear side member extending in substantially the same direction as the first side member, from an opposite edge of the base member, the second side member having a third lip extending toward the base member; and
b. at least one corner post communicatively connected to at least two panels, the at least one post including at least two post walls oriented substantially perpendicularly to each other, each post wall including a post wing extending from the post wall and toward each other;
whereby the at least two panels and the at least one corner post cooperate to form at least two walls.

19. The enclosure of claim 18, wherein the panels are modular and are connected to the posts, one of the post wings abutting the second lip of one of the at least two modular panels and the other post wing abutting the second lip of the other of the at least two modular panels, and wherein the first side members of the at least two panels extend generally perpendicularly from the respective base members, the second side members extend generally perpendicularly from the respective base embers, and the third lips extend generally perpendicularly from the respective second side members.

20. The enclosure of claim 19, further comprising at least one additional modular panel connected to form a linearly configured wall.

21. The enclosure of claim 19, further comprising at least one ceiling panel connected to the at least two walls.

22. A self supporting, fastenerless spray booth comprising:
a. at least one wall comprising at least two wall panels, each wall panel comprising
i. a rectilinear base member having outer edges;
ii. a first rectilinear side member extending from one edge of the base member, the first side member having a first lip extending from an outward edge of the first side member and away from the base member, the first side member further having a second lip extending from an outward edge of the first lip and toward the base member and at an angle between about zero and 90 degrees with respect to the first lip; and
iii. a second rectilinear side member extending in substantially the same direction as the first side member, from an opposite edge of the base member, the second side member having a third lip extending toward the base member; and
b. at least one ceiling comprising at least one ceiling panel comprising:
i. a rectilinear base member having outer edges;
ii. a first rectilinear side member extending from one edge of the base member, the first side member having a first lip extending from an outward edge of the first side member and away from the base member, the first side member further having a second lip extending from an outward edge of the first lip and toward the base member and at an angle between about zero and 90 degrees with respect to the first lip; and
iii. a second rectilinear side member extending in substantially the same direction as the first side member, from an opposite edge of the base member, the second side member having a third lip extending from the second side member and toward the base member.

23. The self supporting spray booth of claim 22, wherein each wall panel is modular and wherein the ceiling further includes a panel comprising:
a. a rectilinear base member having outer edges;
b. a first rectilinear side member extending from one edge of the base member, the first side member having a slot wall extending downward from an outward edge of the first side member and away from the base member; and
c. a second rectilinear side member extending in substantially the same direction as the first side member, from an opposite edge of the base member, the second side member having a lip extending from the second side member and toward the base member.

24. The self supporting spray booth of claim 22, wherein the at least one ceiling panel further includes at least one shoulder wall extending generally perpendicularly from a further edge of the base member, the shoulder wall including a slot wall extending downwardly from an outward edge of the shoulder wall.

25. The self supporting spray booth of claim 22, wherein the first side members of the at least two wall panels extend generally perpendicularly from the respective base members, the second side members extend generally perpendicularly from the respective base members, and the third lips extend generally perpendicularly from the respective second side members.

26. A self supporting, fastenerless spray booth comprising:
a. at least one wall comprising at least two wall panels, each wall panel comprising
i. a rectilinear base member having outer edges;
ii. a first rectilinear side member extending from one edge of the base member, the first side member having a first lip extending from an outward edge of the first side member and away from the base member, the first side member further having a second lip extending from an outward edge of the first lip and toward the base member and at an angle between about zero and 90 degrees with respect to the first lip; and
iii. a second rectilinear side member extending in substantially the same direction as the first side member, from an opposite edge of the base member, the second side member having a third lip extending toward the base member; and
b. at least one ceiling comprising at least one ceiling panel comprising:
i. a rectilinear base member having outer edges;
ii. a first rectilinear side member extending from one edge of the base member, the first side member having a slot wall extending downward from an outward edge of the first side member and away from the base member; and
iii. a second rectilinear side member extending in substantially the same direction as the first side member, from an opposite edge of the base member, the second side member having a lip extending from the second side member and toward the base member.

27. The self supporting spray booth of claim 26, wherein each wall panel is modular and wherein the ceiling further includes a panel comprising:
a. a rectilinear base member having outer edges;
b. a first rectilinear side member extending from one edge of the base member, the first side member having a first lip extending from an outward edge of the first side member and away from the base member, the first side member further having a second lip extending from an outward edge of the first lip and toward the base member and at an angle between about zero and 90 degrees with respect to the first lip; and
c. a second rectilinear side member extending in substantially the same direction as the first side member, from an opposite edge of the base member, the second side member having a third lip extending from the second side member and toward the base member.

28. The self supporting spray booth of claim 26, wherein the first side members of the at least two wall panels and the at least one ceiling panel extend generally perpendicularly from the respective base members, the second side members extend generally perpendicularly from the respective base members, and the third lips extend generally perpendicularly from the respective second side members.

29. A spray booth comprising:
a. a plurality of panels having opposite ends selectively arrangable in series with opposing ends of adjacent panels being attached together to form a spray booth wall;
b. at least one channel formed at one of the ends of at least one of the panels; and
c. a post securable to an adjacent panel and rotationally engageable within the at least one channel to releasably engage the at least one panel to attach the ends of the adjacent panels.

30. A spray booth in accordance with claim 29 wherein the post includes at least one post wing insertable through a channel opening defined by the at least one end.

31. A spray booth in accordance with claim 29 wherein the at least one channel includes a first lip positioned at the one of the ends, and a second lip oriented at an acute angle with respect to the first lip.

32. A spray booth in accordance with claim 31 wherein the post includes a post wing insertable through a channel opening defined by the at least one end, and wherein the post wing abuts the second lip.

33. A spray booth in accordance with claim 32 wherein the post wing abuts the first lip.

34. A spray booth in accordance with claim 29 wherein the at least one channel includes a first lip positioned at the one of the ends, a second lip projecting from the first lip, and wherein the post includes a post wing insertable through a channel opening defined by the at least one end, the post wing abuting the second lip.

35. A spray booth in accordance with claim 34 wherein the post wing abuts the second lip at a post wing end.

36. A spray booth in accordance with claim 34 wherein the first lip is oriented parallel to the at least one of the panels.

37. A spray booth in accordance with claim 29 wherein the at least one channel includes a first lip positioned at the one of the ends and a second lip defining a hook-corner, and wherein the post is engageable within the at least one channel at the hook-corner.

38. A spray booth in accordance with claim 29 further comprising:
a. at least two channels, each one formed along a length of one of the ends of the adjacent panels; and
b. wherein the post is rotationally engageable within both of the at least two channels.

39. A spray booth in accordance with claim 29,
wherein the plurality of panels includes at least two panels attached end-to-end in series in a perpendicular orientation;
wherein the at least two panels each include a channel formed along opposing ends of the panels, and
wherein the post includes a Winged-L-shaped coupler, cooperating with the opposing channels to removeably hold the panels together.

40. A spray booth according to claim 29:
wherein the plurality of side panels includes at least two side panels attachable end-to-end in series in a co-linear orientation; and
wherein at least one of the two panels includes at least another channel formed at one of the ends opposing the end of the other panel wherein the at least one of the two panels is rotationally engageable with the other panel at the at least another channel to removeably hold the at least two panels together in a co-linear orientation.

41. A spray booth in accordance with claim 40, wherein the at least another channel and the post are vertically oriented.

42. A spray booth in accordance with claim 40, wherein the at least another channel extends along a majority of a length of the end of the at least two panels, and locks a majority of the length of the ends of the at least two panels together.

43. A spray booth in accordance with claim 40 wherein the other panel includes a third lip insertable into the at least one channel.

44. A spray booth in accordance with claim 40 wherein the at least another channel includes a first lip and a second lip oriented at an acute angle with respect to the first lip.

45. A spray booth in accordance with claim 44 wherein the other panel includes a third lip insertable through a channel opening of the channel, and wherein the third lip abuts the second lip.

46. A spray booth in accordance with claim 40 further comprising:
a ceiling panel having at least one slot wherein the ceiling panel engages with at least one of the side panels at the slot.

47. A spray booth in accordance with claim 46 wherein the slot is formed along an end of the top panel and wherein the slot drops over the side of a side panel.

48. A spray booth in accordance with claim 46 wherein the slot extends along a majority of a length of the ceiling panel and locks a majority of the length of the at least one panel.

49. A spray booth in accordance with claim 46 wherein the ceiling panel has two slots and engages with two side panels attached end-to-end in series in a perpendicular orientation.

50. A spray booth in accordance with claim 46 wherein the ceiling panel includes a lip engageable with a second ceiling panel.

51. A spray booth in accordance with claim 46 wherein the ceiling panel includes a second lip extending from a first lip, and wherein the second lip is oriented at an acute angle with respect to the first lip.

52. A spray booth in accordance with claim 30 wherein the post includes a post channel, the adjacent panel rotationally engageable within the post channel to releaseably engage the adjacent panel to the at least one panel.

53. A spray booth in accordance with claim 52 wherein the post channel includes a post hook wall oriented at an acute angle with respect to the post wing.

54. A spray booth in accordance with claim 53 wherein the at least one of the panels includes a third lip which abuts with the post hook wall.

55. A spray booth in accordance with claim 52 wherein the post includes a generally S-shaped coupler, cooperating with the opposing side panels to removeably hold the panels together.

56. A spray booth comprising:
a. a plurality of panels having opposite ends selectively arrangable in series with opposing ends of adjacent panels being attached together to form a spray booth wall;
b. at least one channel formed at one of the ends of at least one of the panels, the at least one channel including a first lip positioned at the one of the ends and a second lip oriented at an acute angle with respect to the first lip; and
c. a post securable to an adjacent panel, the post including a post wing insertable through a channel opening defined by the at least one end, the at least one panel rotationally engageable with the post at the at least one channel wherein the post wing abuts the second lip to engage the end of the at least one panel to the adjacent panel.

57. A spray booth in accordance with claim 56 wherein the post includes a post channel formed opposite the at least one post wing, the adjacent panel rotationally engageable within the post channel to releaseably engage the adjacent panel to the end of the at least one panel.

58. A spray booth in accordance with claim 57 wherein the post channel includes a second post wing, and a post hook wall oriented at an acute angle with respect to the second post wing.

59. A spray booth in accordance with claim 56 further comprising a top panel having at least one slot wherein the top panel engages with at least one of the panels at the slot.

60. A spray booth in accordance with claim 59 wherein the plurality of panels includes at least two panels attached end-to-end in series and wherein at least one of the two panels includes at least another channel formed at one of the ends opposing the end of the other panel, the at least one of the two panels rotationally engageable with the other panel at the at least another channel to removeably hold the at least two panels together.

61. A spray booth in accordance with claim 59 wherein the top panel includes a channel configured to engage with an adjacent top panel.

62. A spray booth comprising:
at least two adjacent panels having opposite ends being attached together to form a spray booth wall;
at least one channel formed at one of the ends of at least one of the panels, the channel including a first lip positioned at the one of the ends and a second lip oriented at an acute angle with respect to the first lip; and
a post securable to an adjacent panel and removeably receivable within the at least one channel to releasably engage the at least one panel to engage the ends of the adjacent panels.

63. A spray booth in accordance with claim 62 wherein the post includes a post wing having a post wing end insertable through a channel opening defined by the at least one channel, and wherein the post wing end abuts the second lip.

64. A spray booth in accordance with claim 62 further comprising:
a. at least another channel including a first lip positioned at the one of the ends and a second lip oriented at an acute angle with respect to the first lip; and
b. wherein the post is removeably receivable within both of the at least two channels.

65. A spray booth in accordance with claim 62,
wherein the at least two panels are attached end-to-end in series in a perpendicular orientation;
wherein the at least two panels each include a channel formed along opposing ends of the panels, and
wherein the post includes a Winged-L-shaped coupler, cooperating with the opposing channels to removeably hold the panels together.

66. A spray booth according to claim 62:
wherein the at least two panels are attachable end-to-end in series in a co-linear orientation; and
wherein at least one of the panels includes at least another channel formed at one of the ends opposing the end of the other panel wherein the at least one of the two panels is removeably receivable with the other panel at the at least another channel to removeably hold the at least two panels together in a co-linear orientation.

67. A spray booth according to claim 62 further comprising:
at least another panel are attachable end-to-end in series with at least one of the at least two panels in a co-linear orientation; and
wherein the another panel includes a channel formed at one of the ends opposing the end of at least one of the at least two panels, the other panel having first lip and a second lip oriented at an acute angle with respect to the first lip, the at least one of the at least two panels including a third lip and wherein the third lip abuts the second lip to removeably hold the another panel to the at least one of the at least two panels together in a co-linear orientation.

68. A spray booth according to claim 62 further comprising a top panel having at least one slot wherein the top panel engages with at least one of the panels at the slot.

69. A spray booth structural member such as a wall or ceiling comprising:
at least two adjacent panels having opposite side ends being attached together to form a spray booth wall; and
at least one channel formed at one of the ends of one of the panels opposing the end of the adjacent panel, the at least one channel including a first lip and a second lip oriented at an acute angle with respect to the first lip, the adjacent panel having a third lip abutting the second lip to removeably hold the adjacent panels together in a co-linear orientation.

70. A spray booth in accordance with claim 69 wherein the at least one of the panels is rotationally engageable with the adjacent panel at the at least one channel.

71. A spray booth in accordance with claim 69 wherein the booth further comprises a top panel having at least one slot wherein the top panel engages with at least one of the panels at the slot.

72. A method of assembling an enclosure comprising the steps of:
a. providing at least two panels, each panel including:
i. a rectilinear base member having outer edges;
ii. a first rectilinear side member extending perpendicularly from one edge of the base member, the first side member having a first lip extending from an outward edge of the first side member and away from the base member and at an angle between about m and n degrees with respect to the first side member, the first side member further having a second lip extending from an outward edge of the first lip and toward the base member and at an angle between about o and p degrees with respect to the first lip; and
iii. a second rectilinear side member extending perpendicularly, in the same direction as the first side member, from an opposite edge of the base member, the second side member having a third lip extending perpendicularly from the second side member and toward the base member;
b. providing at least one corner post communicatively connectable to at least two panels, the at least one post including at least two post walls oriented substantially perpendicularly to each other, each post wall including a post wing extending substantially perpendicularly from the post wall and toward each other; and
c. communicatively connecting the at least two panels together with the at least one corner post to form at least two walls of the enclosure.

73. The method of assembly of claim 72 wherein the panels are modular, one of the post wings abutting the second lip of one of the at least two modular panels and the other post wing abutting the second lip of the other of the at least two modular panels.

74. The method of assembly of claim 73 further comprising at least one additional modular panel connected to form a linearly configured wall.

75. The method of assembly of claim 73 further comprising at least one ceiling panel connected to the at least two walls.

76. A method of assembling a spray booth comprising the steps of:
providing a plurality of side panels having opposite side ends selectively arangable in series with opposing side ends of adjacent side panels, at least one channel formed at one of the side ends of at least one of the side panels, and a post securable to an adjacent side panel and rotationally engageable within the at least one channel to releasably engage the at least one side panel;
rotationally engaging the post within the at least one channel; and
securing an adjacent side panel to the post to engage the side ends of the adjacent side panels to form a spray booth wall.

77. A method of assembling a spray booth in accordance with claim 73 further comprising the steps of providing a top panel having at least one slot and engaging the top panel with at least one of the side panels at the slot.

78. A method of assembling a spray booth comprising the steps of:
providing a plurality of side panels having opposite side ends selectively arrangable in series with opposing side ends of adjacent side panels, at least one channel formed at one of the side ends of at least one of the side panels, the channel including a first lip positioned at the one of the side ends and a second lip oriented at an acute angle with respect to the first lip, and a post securable to an adjacent side panel and removeably receivable within the at least one channel to releasably engage the at least one side panel to engage the side ends of the adjacent side panels;
arranging the side panels in series;
removeably receiving the post within the at least one channel; and
securing an adjacent side panel to the post to engage the side ends of the adjacent side panels to form a spray booth wall.

79. A method of assembling a spray booth in accordance with claim 75 further comprising the steps of providing a top panel having at least one slot and engaging the top panel with at least one of the side panels at the slot.

80. A method of assembling a spray booth in accordance with claim 76 wherein the plurality of side panels includes at least two side panels attachable end-to-end in series and wherein at least one of the two side panels includes at least another channel formed at one of the side ends opposing the side end of the other side panel, further comprising the step of rotationally engaging the at least one of the two side panels with the other side panel at the at least another channel to removeably hold the at least two side panels together in a co-linear orientation.

81. A self-supporting, fastenerless enclosure comprising:
a plurality of side panels having opposite side ends selectively arrangable in series with opposing side ends of adjacent side panels being attached together to form a wall of the enclosure;
at least one channel formed at one of the side ends of at least one of the side panels, the channel including a first lip positioned at the one of the side ends and a second lip oriented at an acute angle with respect to the first lip;
a post securable to an adjacent side panel and removeably receivable within the at least one channel to releasably engage the at least one side panel to engage the side ends of the adjacent side panels; and
at least one top panel having at least one slot wherein the top panel engages with at least one of the side panels at the slot.

82. The enclosure in accordance with claim 81 further comprising:
a. at least another channel including a first lip positioned at the one of the side ends and a second lip oriented at an acute angle with respect to the first lip; and
b. wherein the post is removeably receivable within both of the channels.

83. A modular panel for use in conjunction with like modular panels for assembling a structural member of an enclosure, the modular panel comprising:
a sheet of material having first and second sides;
a first channel formed at one of the sides, the channel having a channel opening, a first lip, and a second lip oriented at an acute angle with respect to the first lip; and
a second channel formed at the other of the sides, the second channel having a third lip insertable through a first channel opening of an adjacent modular panel and abuttable with a second lip of the adjacent modular panel of like variety;
wherein the third lip abuts the second lip of the adjacent modular panel to removeably hold the modular panel and adjacent panel together in a co-linear orientation.

84. A corner post for coupling two panels together in a generally perpendicular orientation, comprising:
at least two post walls oriented generally perpendicularly to each other;
each post wall including a post wing extending from the post wall and toward each other.

85. The post of claim 84, wherein the post wings extend generally perpendicularly with respect to the respective post walls.

86. The post of claim 84, wherein the post walls are rectilinear and connect to form a generally L-shaped configuration.
